(19) United States
(12) Patent Application Publication
(10) Pub. No.: US 2007/0288850 A1
(43) Pub. Date: Dec. 13, 2007

(54) APPLICATION SHARING

(75) Inventor: Joseph T. Fletcher, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/423,338

(22) Filed: Jun. 9, 2006

(51) Int. Cl. G06F 15/16

(52) U.S. Cl. 715/751; 709/227

(57) ABSTRACT

A facility is provided for application sharing. In various embodiments, the facility configures an application for application sharing so that it provides sharing actions directly within the application. The facility receives a command from the application to share and shares the application or document that was indicated to be shared.

### BACKGROUND

People sometimes use application sharing software to share documents or applications. Application sharing software enables a sharer to share display information from the sharer's computing device to other computing devices that are used by participants in an application sharing session. The other computing devices can be referred to as viewer computing devices. When a sharer shares a document or application with participants, the sharer computing device and the viewer computing devices may display identical or similar information during the application sharing session. As an example, the computing devices may display the same applications, documents, or other images.

Conventionally, a sharer shares a document or application by starting the application sharing software and then indicating which application or document is to be shared. As an example, if a sharer desires to share a MICROSOFT WORD document or a MICROSOFT EXCEL spreadsheet, the sharer starts the application sharing software or switches from MICROSOFT WORD or EXCEL to the application sharing software, indicates which application or document is to be shared, and then switches back to MICROSOFT WORD or EXCEL. The application sharing software then provides data or display information from the sharer computing device to the viewer computing devices so that the participants can view what the sharer views. As an example, the application sharing software can interface with the graphical device interface (“GDI”) of the operating system on which the application sharing software operates to transmit to the viewer computing devices calls made to the GDI by the application that is shared or the application displaying the document that is shared. The GDI is an operating system component that transforms data or drawing commands into data suitable for display on a display device. Upon receiving indications of the GDI calls sent by the sharer computing device, application sharing software operating on the viewer computing devices make similar calls so that the viewer computing devices show identical or similar information. As another example, the application sharing software can interface with the GDI to capture changes to the sharer computing device's display device and send indications of the changes to the connected viewer computing devices so that they too can display the same or similar changes on their display devices.

Changing from an application that the sharer is using (e.g., MICROSOFT WORD or EXCEL) to the application sharing software creates a user context switch. A user context switch occurs when a user stops performing an activity to perform a different activity. When this occurs, users can forget what they were previously doing or make errors, and generally find such context switches to be disturbing because they can cause poor user experience, require additional time to complete a task, and make it more difficult to collaborate. Users are sometimes unwilling or unable to make such context switches. As an example, users sometimes find it cognitively difficult to switch between executing applications. Consequently, some users can find it difficult to share applications or documents because they need to switch between an application or document they desire to share and the application sharing software.

### SUMMARY

A facility is described for controlling application sharing from outside the application sharing software. The application sharing software provides components, such as “add-ins” or an application program interface, that enable other applications to control application sharing directly using the user interfaces provided by the other applications without requiring a user context switch to the application sharing software. These components provide commands to the application sharing software to control the application sharing. The application sharing program shares the other application or a document the other application opens, as commanded. Thus, the user does not need to experience a user context switch that is caused by switching from the other application to the application sharing software.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating a computing environment in which the facility operates in some embodiments.

FIG. 2 is a flow diagram illustrating a register_application routine invoked by the facility in some embodiments.

FIGS. 3 and 4A-4B are display diagrams illustrating user interfaces provided by the facility in various embodiments.

FIG. 5 is a flow diagram illustrating a receive_command routine invoked by the facility in some embodiments.

FIG. 6 is a flow diagram illustrating an enable_sharing routine invoked by the facility in some embodiments.

### DETAILED DESCRIPTION

A facility is described for controlling application sharing from outside an application sharing software. In various embodiments, the application sharing software provides components that enable other applications (“shareable applications”) to control application sharing directly using the user interfaces provided by the shareable applications without requiring a user context switch to the application sharing software. As an example, the application sharing software provides one or more “add-in” components that each provide additional functionality that, from a user perspective, appears to be directly provided by the shareable applications. An add-in is a component that is generally installed separately from an application with which the add-in operates, but the functionality it provides appears to the user to be provided by the application itself. The add-in can be installed with a sharable application, with the application sharing software, or with other components, and can operate when the shareable application or application sharing software execute. An add-in can also modify the user interface of the application, such as to provide commands associated with the add-in. When the shareable application starts, it can provide sharing-related commands even though the shareable application was not originally designed to control the application sharing software. As an example, an add-in may cause a shareable application to display a button on its title bar or elsewhere in its user interface that, when selected, performs a command to start or control the application sharing software. As another example, an add-in may cause a shareable application to display a button that, when selected, commands the application sharing software to share with participants the shareable application or a document that the shareable application opens. The application sharing program shares the shareable application or the document, as commanded. Thus, the user does not need to experience a user context switch that is caused by switching from the shareable application to the application sharing software to control the application sharing software.

Examples of sharable applications that conventionally are not designed for inherent sharing are word processing applications such as MICROSOFT WORD, spreadsheet applications such as MICROSOFT EXCEL, presentation graphics applications such as MICROSOFT POWERPOINT, and so forth. Many of these applications, however, support add-ins, such as by using MICROSOFT'S add-in model. When the application sharing software is installed, it can also install add-ins for these and other applications so that the shareable applications can start and control application sharing. Alternatively, the shareable applications may install the add-ins, such as when the shareable applications detect that the application sharing software is installed. As used herein, the term “application sharing” includes document sharing.

In some embodiments, a shareable application may not employ add-ins. Instead, the shareable application may employ an application programming interface (“API”) to cause the application sharing software to share the shareable application or a document it opens. As an example, a shareable application may detect that the application sharing software is installed and provide options in the shareable application's user interface that cause the application sharing software to perform various activities (e.g., to share the shareable application or a document it opens). When these options are selected, the shareable application can invoke various methods provided by the application sharing software's API, such as to share the application. Thus, for example, the shareable application may provide user interface elements relating to sharing, such as a sharing button on its title bar, menu option, and so forth. When selected, these user interface elements cause the shareable application to invoke a corresponding method in the application sharing software's API.

In various embodiments the user can select whether to share the shareable application or a document that the shareable application has opened. As an example, the user can make a selection to share MICROSOFT WORD. Alternatively, the user can make a selection to share a subset of the set of documents that MICROSOFT WORD has opened. Thus, the user can share an application and all its document windows or selectively share some of the open document windows but not others. The user can select the application or open documents from within the user interface of the shareable application or by a user interface provided by an associated add-in.

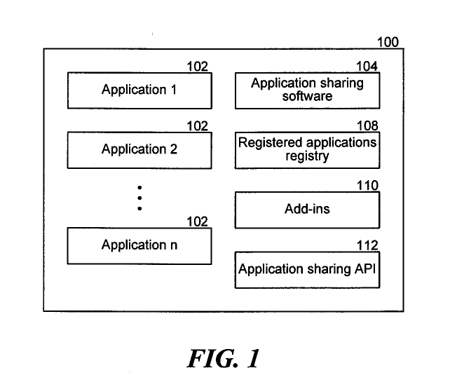

Turning now to the figures, FIG. 1 is a block diagram illustrating a computing environment 100 in which the facility operates in some embodiments. The computing environment includes one or more applications 102. The applications can be shareable applications. An application is shareable when it is configured for sharing, such as by using an add-in 110 or invoking an API associated with the facility, such as an application sharing API 112. The application sharing API and add-ins 110 operate in association with an application sharing software 104. An example of an application sharing software is MICROSOFT LIVEMEETING. LIVEMEETING generally enables a sharer to share an application or document with a large number of participants. Another example of an application sharing software is software that enables a sharer to share an application or document with a small number of participants so that the sharer and participants can jointly and actively collaborate on a document. The application sharing software generally enables users to collaboratively use an application. As an example, when MICROSOFT WORD is shared between a sharer and a participant, the sharer or participant can edit an open document. The computing environment additionally has a registry 108 for storing information associated with registered applications. As an example, an application that has an add-in but is indicated by an administrator to be not shareable may not be listed in the registered applications registry. Alternatively, the registry may store an indication that the application is not to be shared. The registry can also store indications of applications that are shareable. These include applications that have associated add-ins, employ the application sharing API, and so forth. The registry can be stored in various storage devices associated with the computing environment, such as an operating system registry or other storage.

The illustrated computing environment 100 can operate in the context of general purpose or specifically configured computers. Components of the computers may include, but are not limited to, a processing unit, a system primary memory, a storage device, a network adapter or interface, a display, and one or more input and output devices. A computer typically includes a variety of computer-readable media that are operable with the storage device. Computer-readable media can be any available media that can be accessed by the computer and include both volatile and nonvolatile media and removable and nonremovable media.

The computer may operate in a networked environment using logical connections to one or more remote computers. A remote computer may be a personal computer, a server, a router, a network PC, a peer device, or other common network node, and typically includes many or all of the elements described above in relation to the computer. A logical connection can be made via a local area network (LAN) or a wide area network (WAN), but may also include other networks. Such networking environments are commonplace in homes, offices, enterprise-wide computer networks, intranets, and the Internet. The computer can be connected to a network through a network interface or adapter, such as to a wired or wireless network.

The computer is only one example of a suitable computing environment and is not intended to suggest any limitation as to the scope of use or functionality of the facility. The computing system should not be interpreted as having any dependency or requirement relating to any one or a combination of the illustrated components.

The facility is operational with numerous other general purpose or special purpose computing systems or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

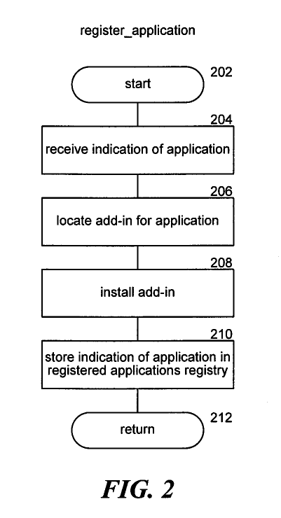

FIG. 2 is a flow diagram illustrating a register_application routine invoked by the facility in some embodiments. The facility invokes the routine when registering shareable applications. As an example, the facility may invoke the routine when an add-in is installed for a shareable application. The routine begins at block 202.

At block 204, the routine receives an indication of the shareable application that is to be registered. The indication can be, e.g., a globally unique identifier for the application, name or directory location of the application, and so forth.

At block 206, the routine locates an add-in for the indicated shareable application. The routine may, e.g., locate the add-in on the Internet, on an intranet, on removable storage, and so forth. The add-in may be provided with the shareable application or with application sharing software.

At block 208, the routine installs the add-in. Installing an add-in may include registering it with the shareable application. When an add-in is registered with an application, the application interacts with the add-in, such as to enable it to display user interface-related information, receive commands, and so forth. When an add-in is registered with an application, a user of the application may be unable to discern whether functionality is provided by the application or the add-in.

At block 210, the routine registers the indicated shareable application, such as by storing the received indication of the application in a registry of shareable applications. When an application is registered, it is capable of commanding the application sharing software, such as to share an application or document.

At block 212, the routine returns.

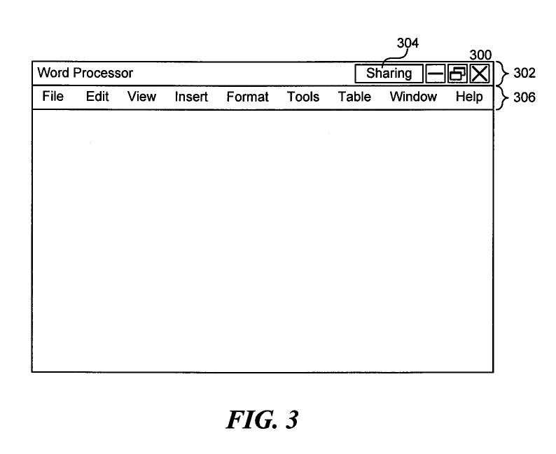

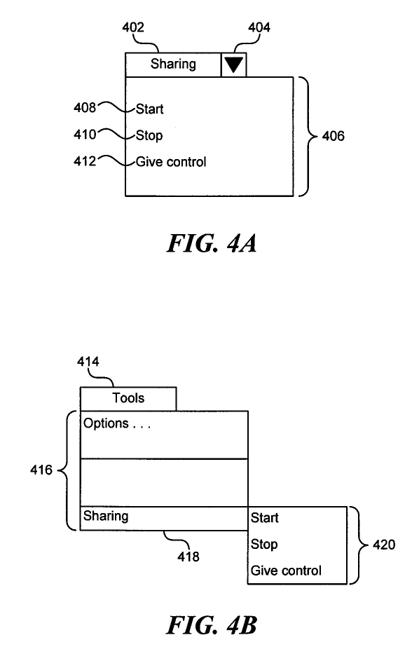

FIGS. 3 and 4A-4B are display diagrams illustrating user interfaces provided by the facility in various embodiments.

FIG. 3 is a display diagram illustrating the main window of a shareable application, such as a word processing application. The illustrated user interface 300 includes a title bar region 302 and a menu region 306. Additionally, the user interface includes a Sharing button region 304. The Sharing button region may be provided by an add-in associated with the word processing application or by the word processing application itself when it is being designed for application or document sharing. When the Sharing button region is selected, the word processor or the open document is shared. In various embodiments, the Sharing button region may appear in the title bar region of a document window in addition to or instead of the title bar region of the shareable application's main window. When the button is selected from the title bar region of the document window, only the document may be shared. When the button is selected from the title bar region of the shareable application's main window, all open documents may be shared. In various embodiments, the user interface may display a window to enable the user to specify whether to share the shareable application (e.g., all open windows) or just an open window.

The Sharing button region may optionally have an associated option selection button, such as the option selection button region 404 associated with a Sharing button region 402 that is illustrated in FIG. 4A. When selected, the option selection button may display an option region 406 containing available commands, such as a Start command 408, Stop command 410, and Give control command 412. In various embodiments, additional commands can be provided. As an example, an Options command can enable the user to set sharing-related options, such as for modifying various attributes of the application sharing software.

The Start command causes the application sharing software to begin sharing the selected application or document window. When the selected application or document window is shared by a sharer, participant computing devices may display a similar or identical window corresponding to the shareable application's display on the display device of the sharer computing device. The sharer and participant may then be able to collaborate using the shared application or document.

The Stop command causes the application sharing software to stop sharing the selected application or document window. The viewer may then be unable to view what is displayed on the sharer computing device.

The Give control command enables a user (e.g., the sharer) to give control of the shared application to another user (e.g., a participant). Then, any input the other user makes (e.g., keyboard or mouse input) is processed by the shared application and displayed on the computing devices of the sharer and other participants. Thus, for example, a participant can add text to a word processing document or spreadsheet even though it was the sharer that shared the application or document. The sharer may then be able to revoke control.

In various embodiments, the sharer may employ an aspect of the user interface (not illustrated) to select the identities of participants or participant computing devices which are authorized for sharing.

FIG. 4B illustrates an alternative embodiment. The sharing can be caused by selecting a command from the shareable application's menu, such as a Tools menu 414. The Tools menu provides a list of commands 416, including a Sharing command 418 which, when selected, displays commands 420 that are similar to the commands discussed above in relation to FIG. 4A.

In various embodiments, the shareable application may employ the Sharing region, menu commands, or both. In various embodiments, user actions may be received via toolbar buttons or other aspects of user interfaces associated with the shareable applications.

While various user interface elements and associated captions (e.g., text or labels associated with the user interface elements) are illustrated and described above, other user interface elements or captions can equally be used to receive indications of user actions.

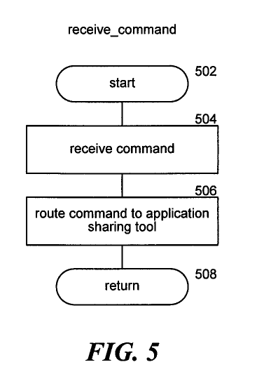

FIG. 5 is a flow diagram illustrating a receive_command routine invoked by the facility in some embodiments. The facility invokes the receive_command routine when it receives a command from an add-in or its API. In various embodiments, the routine can be invoked by an add-in, an API method, or other component. The routine begins at block 502.

At block 504, the routine receives an indication of the command. Examples of commands include start sharing, stop sharing, give control, and so forth.

At block 506, the routine provides the command to the application sharing tool. By providing the command to the application sharing tool, the application sharing tool will be able to perform the desired behavior as if the user had interacted directly with it. Thus, for example, the application sharing tool can begin or end sharing.

The routine returns at block 508.

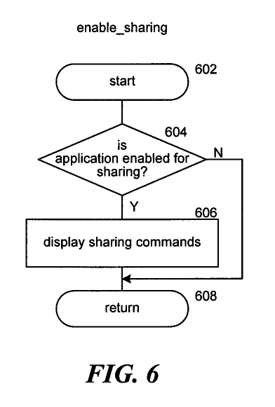

FIG. 6 is a flow diagram illustrating an enable_sharing routine invoked by the facility in some embodiments. An add-in may invoke the routine when it is loaded by an application. Alternatively, an application configured for sharing via use of the sharing application software's API can invoke the routine. The routine begins at block 602.

At block 604, the routine determines whether the application is enabled for sharing. As an example, the routine may check the registered applications registry discussed above in relation to FIG. 1 to make the determination. If the application is enabled for sharing, the routine continues at block 606. Otherwise, the routine continues at block 608, where it returns.

At block 606, the routine displays sharing commands. As examples, the routine may display a sharing button region in a title bar region associated with the application, display commands in the application's menus, and so forth.

At block 608, the routine returns.

In various embodiments, upon indicating to share an application or document, the sharer indicates with whom to share. As an example, the sharer may provide a list of identifiers of users or their computing devices. Alternatively, the sharer may wait for participants to request a connection and selectively enable sharing with the requesting participants.

Those skilled in the art will appreciate that the steps shown in FIGS. 2, 5, and 6 and discussed above may be altered in various ways. For example, the order of the logic may be rearranged, substeps may be performed in parallel, shown logic may be omitted, other logic may be added, etc.

In various embodiments, the application sharing software can share any application or other component that provides a user interface, whether or not such application or component is configured for sharing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I claim:

1. A method performed by a computer system for application sharing, comprising:
providing an application that is configured for application sharing, the configuration causing the application to provide sharing actions to users and thereby becoming a shareable application, the sharing actions for causing a component of an application sharing software to respond to a command;
receiving from a user by the shareable application a selection of a sharing action;
receiving by the component of the application sharing software a command from the shareable application to share in accordance with the selected sharing action; and
sharing, under control of the application sharing software, the shareable application from which the command was received.

2. The method of claim 1 wherein the providing includes installing an add-in that is employed by the shareable application to send commands to the application sharing software in response to the selected sharing action.

3. The method of claim 2 wherein the component of the application sharing software is the add-in.

4. The method of claim 1 wherein the sharing includes giving control of the shareable application to a participant.

5. The method of claim 1 further comprising receiving a command to stop sharing and, under control of the application sharing software, stopping the sharing.

6. The method of claim 1 wherein the providing includes registering the shareable application.

7. The method of claim 1 wherein the received command indicates to share the shareable application.

8. The method of claim 1 wherein the received command indicates to share a document opened by the shareable application.

9. The method of claim 1 wherein the providing includes causing the shareable application to display a sharing command on a title bar associated with the shareable application.

10. The method of claim 1 wherein the providing includes causing the shareable application to display a sharing command in a menu associated with the shareable application.

11. A computer-readable medium having computer-executable instructions that, when executed, cause a computer system to perform a method in a shareable application for application sharing, the method comprising:
determining whether the shareable application is configured to provide application sharing actions; and
when the shareable application is configured to provide application sharing actions,
providing application sharing actions to a user;
receiving from the user a selection of an application sharing action indicating a sharing command; and
commanding an application sharing software to perform the indicated sharing command.

12. The computer-readable medium of claim 11 wherein the determining includes determining whether an add-in has been configured.

13. The computer-readable medium of claim 12 wherein the providing is performed under control of the add-in.

14. The computer-readable medium of claim 11 wherein the sharing command indicates to start sharing.

15. The computer-readable medium of claim 14 wherein an application program interface of the application sharing software shares the shareable application.

16. The computer-readable medium of claim 11 wherein the sharing command indicates to stop sharing.

17. A system for application sharing, comprising:
an application sharing software component that performs sharing; and
a component that provides communications services to a shareable application that can be shared so that the shareable application can command the application sharing software to perform a sharing command, the sharing command indicated by a user employing a user interface of the shareable application, the user interface displaying a sharing command that, when selected, causes the application sharing software component to perform the indicated sharing command.

18. The system of claim 17 wherein the component that provides communications services to the application is an add-in configured for use with the application.

19. The system of claim 17 wherein the component that provides communications services to the application is an application program interface associated with the application sharing software component.

20. The system of claim 17 wherein the application sharing software component can share the shareable application or a document the shareable application opens.
